(19) United States
(12) Patent Application Publication
(10) Pub. No.: US 2012/0279461 A1
(43) Pub. Date: Nov. 8, 2012

(54) Leash pendant

(76) Inventor: Cathy Patricia Levell, Nanaimo (CA)

(21) Appl. No.: 13/067,064

(22) Filed: May 5, 2011

(51) Int. Cl. A01K 27/00

(52) U.S. Cl. 119/794

(57) ABSTRACT

A leash pendant includes a pendant-shaped hollow housing containing a rotatably mounted reel. A length of leash is wound onto and unwound from the reel through a hole in the top of the pendant. The reel is resiliently biased so as to automatically retract the leash into the housing from the leash's extended position when in use. A one-way release mechanism allows extension of the leash and delays retraction of the leash until actuated. The housing is the leash handle. The free end of the leash attaches to a pet's collar.

### FIELD OF THE INVENTION

This invention relates to the field of retractable pet leashes, and in particular to a pet leash pendant for wearing by a pet wherein a retractable leash is wholly contained within a pendant which is sized to be worn by a pet and where the pendant serves as the leash handle when retracting the leash from the pendant.

### BACKGROUND OF THE INVENTION

In the prior art, applicant is aware of various attempts to mount a retractable leash directly to the collar worn by a pet, and in particular, applicant is aware of the following United States Patents: U.S. Pat. No. 7,610,880 which issued Nov. 3, 2009 to Lord for a Animal Control Device, U.S. Design Pat. No. D587,861 which issued Mar. 3, 2009 to Miller for a Dog Leash, U.S. Pat. No. 7,461,615 which issued Dec. 9, 2008 to Albright for a Pet Harness with Retractable Leash, U.S. Pat. No. 7,017,527 which issued Mar. 28, 2006 to Price for a Pet Collar with Retractable Leash, U.S. Pat. No. 6,916,975 which issued Jul. 5, 2005 to Balan for a Retractable Tether for a Pet, U.S. Pat. No. 6,581,547 which issued Jun. 24, 2003 to Austin for a Pet Collar with Retractable Leash, U.S. Pat. No. 6,481,382 which issued Nov. 19, 2002 to Cohn for a Collar with Self-Retracting Leash, U.S. Pat. No. 5,816,198 which issued Oct. 6, 1998 to Peterson for a Counterweighted Pet Leash Retracting Collar, U.S. Pat. No. 4,964,370 which issued Oct. 23, 1990 to Peterson for a Leash Retractor, U.S. Pat. No. 4,977,860 which issued Dec. 18, 1990 to Harwell for a Stay Assembly for Tethering Animals, U.S. Pat. No. 4,328,766 which issued May 11, 1982 to Diebert for a Retracting Collar-Mounted Leash, and U.S. Pat. No. 4,197,817 which issued Apr. 15, 1980 to Crutchfield for a Retractable Dog Leash.

As may be seen, the prior art is replete with attempts to mount retractable dog leashes directly to a pet's collar. These prior art designs thus require the modification of the design of a pet's collar and for the most part require that the leash be carried at all times when the pet is wearing the collar. A collar which has an embedded retractable leash which is worn at all times by a pet will greatly increase the chance that the leash or leash retraction mechanism will become damaged, for example by impact, corrosion, or by infiltration of dirt, sand, pet hair, water etcetera. Thus when the pet owner has occasion to use the retractable leash, which may only be when a regular dog leash has for example been forgotten, the retractable leash may not operate properly or may fail thereby inadvertently releasing the pet from the pet owner's control.

Applicant has determined that it is advantageous for a pet owner to, firstly, not have to go to the expense of purchasing complicated pet collars which incorporate retractable leashes which will be worn by the pet at all times, and has also determined, because often a pet owner does not wish to carry a leash when the leash may only be infrequently required to control the pet, that it is .further advantageous to have a retractable leash embedded within a decorative pendant which may be merely clipped or otherwise releasably fastened to a conventional pet collar when the pet owner desires to take the pet out but does not expect to have to control the pet using a leash at all times. Thus pet owners may continue to use on their pets either for example inexpensive pet collars or pet collars which they prefer for example because of their look or feel or quality. A further advantage of applicants pet leash pendant is that the pet owner may easily have the leash pendant to hand at all times in the event that the pet owner forgets to bring along a conventional pet leash, when for example taking the pet for a walk, in that the leash pendant may be clipped or otherwise releasably fastened to the pet owners key chain in the manner of a key fob, or purse or belt, or the like so as to be on hand and ready for use whenever a pet owner so requires.

### SUMMARY OF THE INVENTION

In summary, the leash pendant for wearing by a pet, as described more fully herein, may be characterized in one aspect as including a housing formed as a pendant, where the housing encases a leash mounted on a leash retracting reel, and wherein the housing is adapted to hang from a pet collar and is sized and shaped in the manner of a pendant.

In particular the housing is a substantially hollow housing defining a cavity, and having an aperture in an upper end or top of the housing so that the aperture communicates with the cavity. The leash retracting reel is rotatably mounted within the cavity for rotation about its axis of rotation. The leash is a flexible leash wound in a winding around the reel. The leash in the winding has a base end mounted to the reel so as to form a base of the winding. The leash has a free end, opposite to the base end, which is journalled through the aperture in the top of the housing so as to be disposed outwardly of the housing. The leash extends through the aperture for selective extension and retraction between extended and retracted positions. The aperture in the top of the housing lies on a leash translation axis which is substantially perpendicular to the axis of rotation of the reel.

The reel is resiliently biased by a selectively actuable rewinder to rotate the reel about its axis of rotation in a winding-on direction whereby the leash, when un-wound from the reel in the extended position so as to extend substantially along the leash translation axis, is re-wound onto the reel into the retracted position by selective actuation of the rewinder. In one embodiment the rewinder is a coil spring.

A pet collar coupler is mounted to the free end of the leash. The pet collar coupler is adapted for selectively releasable mounting to a pet collar so as to allow the housing to depend downwardly from the pet collar with the leash translation axis substantially vertical and with the upper end of the housing adjacent the pet collar coupler when the leash is in the retracted position. The housing may thus hang freely and downwardly, adjacent and underneath the pet collar when worn by a pet. The coupler may include a swivel for rotation of the housing or a clip to stabilize the movement of the housing (so it does not rotate) about the leash translation axis.

The housing is sized to accommodate the reel and the leash winding on the reel. In one embodiment, in order to reduce size, the leash may be high-tensile strength filament of a length in the range of substantially two and one half to six feet. Because of the corresponding bulk of the reel and winding, and because the axis of rotation of the reel is perpendicular to the leash translation axis, the housing has a pair of shoulders on opposite sides of the aperture on top of the housing in order to accommodate the bulk. The shoulders provide a bulky handle for grasping by a user when tensioning the leash to extend the leash from the housing against a resistance to the tensioning provided by the rewinder when the free end of the leash is anchored to the pet collar when worn by the pet.

The housing is shaped to provide the pair of shoulders. For example, the shape of the housing may be chosen from the group including: substantially a heart-shape, substantially a round-shape, substantially a rectangular or square paralleopiped or other three dimensional rectilinear shape, substantially an insect-shape, substantially an animal-shape, substantially a flower-shape, substantially ovoid, substantially tear-drop shaped, substantially star-shaped.

The housing has a height dimension along the leash translation axis, a thickness dimension along the axis of rotation of the reel, and a width dimension substantially orthogonal to the axis of rotation of the reel and the leash translation axis. The coupler has a length dimension substantially along the leash translation axis.

Advantageously, a releasable one-way ratchet is provided. The one-way ratchet cooperates with the reel when the reel is rotated so as to unwind the leash winding through the aperture on top of the housing. Upon tensioning of the leash the reel unwinds against a return biasing resilient force of the rewinder. The return biasing resilient force of the rewinder is checked by the one-way ratchet, whereby when the leash is pulled from the housing by a user pulling on the housing, the leash remains extended from the housing until the ratchet is released by the user. Once so released, the rewinder resiliently urges rotation of the reel so as to re-wind the leash onto the reel to thereby retract the leash.

In one embodiment the ratchet includes a resiliently biased latch bar and the reel includes teeth, or otherwise raised contour surfaces. The latch bar is resiliently urged against the teeth on the reel so as to allow only one-way rotation of the reel corresponding to un-winding of the leash from the reel. A latch bar release may be provided which is manually operable from outside of the housing to selectively disengage the latch bar from the teeth to allow for the re-winding of the leash onto the reel. The latch bar may be elongate perpendicular to the axis of rotation of the reel. The latch bar release may be an elongate member such as a shaft or pin extending along the axis of rotation of the reel, wherein one end of the member protrudes from the housing and an opposite end of the member engages against the latch bar. Depression by the user of the one end of the member along the axis of rotation of the reel drives the latch bar along the axis of rotation and out of the plane of rotation of the teeth.

### BRIEF DESCRIPTION OF THE DRAWINGS

FIG. 1 is, in partially exploded perspective view, the leash pendant according to one embodiment of the present invention.

FIG. 2a is, in perspective view, the assembled leash pendant of FIG. 1.

FIG. 2b is, in rear elevation view, the leash pendant of FIG. 2a.

FIG. 2c is, in right side elevation view, the left side elevation being the mirror image thereof, the leash pendant of FIG. 2a.

FIG. 2d is, in front elevation view, the leash pendant of FIG. 2a.

FIG. 2e is, in plan view, the leash pendant of FIG. 2a.

FIG. 3 is a section view along line 3-3 in FIG. 2d.

FIG. 4 is, in side elevation, a pet wearing a collar wherein the collar has the leash pendant of FIG. 2a attached thereto.

FIG. 5 is the view of FIG. 4 with the leash of the leash pendant extended from the pendant housing.

FIG. 6a is, in rear perspective view, the reel and latch bar of FIG. 1.

FIG. 6b is, in front perspective view, the reel of FIG. 6a.

FIG. 6c is, in rear elevation view, the reel of FIG. 6a.

FIG. 6d is, in side elevation, the reel of FIG. 6c.

FIG. 7 is, in perspective view, the shaft and latch bar of FIG. 1.

FIG. 8a is a parrellelopiped form of the leash pendant according to another aspect of the present invention.

FIG. 8b is a spherically shaped form of the leash pendant according to another aspect of the present invention.

FIG. 8c is a heart-like form of the leash pendant according to another aspect of the present invention.

FIG. 8d is a disc-like form of the leash pendant according to another aspect of the present invention.

FIG. 8e is a star-shaped form of the leash pendant.

FIG. 8f is a diamond-shaped form of the leash pendant.

FIG. 8g is a cupcake-shaped form of the leash pendant.

FIG. 8h is a dog-bone-shaped form of the leash pendant

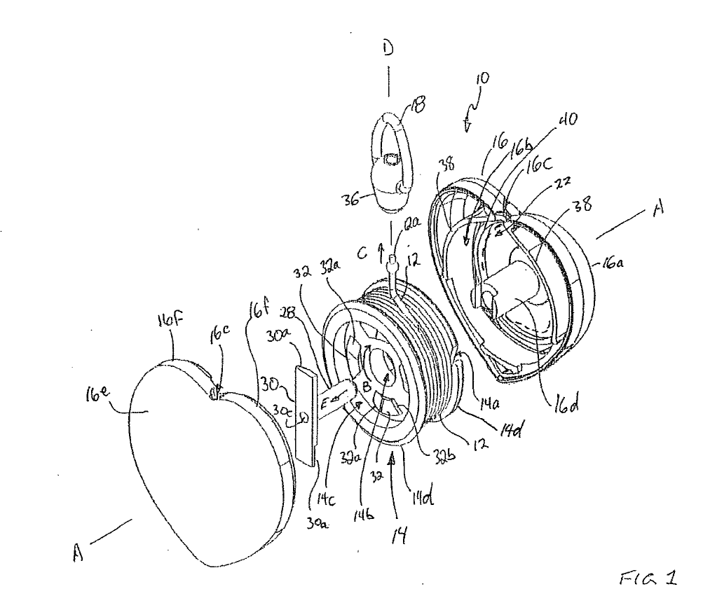

### DETAILED DESCRIPTION OF EMBODIMENTS OF THE INVENTION

As seen in the accompanying figures wherein like reference numerals denote corresponding parts in each view, the leash pendant 10 includes an elongate flexible leash 12 which may be a high-tensile strength filament, wound onto a reel 14 which is rotatably mounted within a housing 16 which serves as the outwardly visible case of the pendant. The free end 12a of leash 12 is provided with a clip 18 or other releasable fastener, for example a spring-loaded clip or carabiner or loop of hook-and-loop fastener tape or other releasable fastener known in the art. The releasable fastener on the free end of the leash releasably attaches the free end of the leash to a conventional pet collar 20, for example to the metal D-ring 20a often mounted into the collar near the collar buckle. Thus the weight of the pendant when clipped to the D-ring of the collar biases the D-ring downwardly so that the pendant hangs naturally in a jewellery-like fashion downwardly from the bottom of the collar, and thereby also biases the collar buckle to a position generally underneath the neck of pet 8 where the buckle remains out of view.

With the free-end 12a of the leash thereby attached to the collar D-ring 20a, and with the leash 12 retracted into the housing 16, the housing hangs like a jewellery pendant a short distance beneath the collar, that is separated from the collar only by the length of the clip and D-ring. When the pet owner desires to use the retractable leash 12 the pet owner (not shown) grasps the pendant housing 16 and gently pulls on the housing thereby both rotating the pendant and collar so as to position the pendant upwardly on the neck of the pet, and to extend the leash 12 from the housing 16 by the action of leash 12 unwinding from reel 14 within the housing.

The base end of the leash, that is, the end opposite the free end 12a of the leash, is mounted to the reel, for example in slot 14a, so that when the leash is fully extended, that is, fully unwound from the reel, the base end of the leash remains anchored within the housing. The housing may thus operate as a handle at the end of the conventional length of leash when the retractable leash is fully extended, that is fully unwound from the reel.

The reel 14 is rotatably mounted within the housing 16 and is resiliently biased, for example by means of a helical coiled spring 22 (shown in dotted outline) so as to urge the reel to rewind the leash onto the reel when the tension on the leash caused by pulling between the housing and the pet collar is removed. A one way ratchet mechanism 24 mounted within the housing 16 and cooperating with the reel 14 allows the extension of the leash 12, that is, the unwinding of the leash from the reel without the leash retracting into the housing whenever the tension on the leash is let up, for example, when the pet approaches the pet owner and the leash therefore goes slack. A latch release mechanism 26 is provided so that the pet owner may release the one-way latch thereby allowing the reel to wind-on the leash from its extended position to its fully retracted position when the owner desires to re-store the leash and return the housing to its position under the pet's neck, where the housing once again appears as a jewellery style pendant hanging freely from and below the pet collar.

In one embodiment which is not intended to be limiting, the reel 14 has a central bore 14b extending therethrough along the reel's axis of rotation A. A shaft or pin 28 extends from one side 16a of the housing 16 into the cavity 16b defined by the walls of the housing and within which the reel is rotatably mounted by the shaft or pin 28 being journalled through a shaft casing 16d, itself journalled through bore 14b of reel 14. The shaft or pin 28 has an internal end 28a protruding into the housing cavity 16b, and an opposite external end 28b protruding through aperture 16a′ in side wall 16a. A latch bar 30 is mounted in a channel 28c on the internal end 28a of the shaft or pin 28 so that the latch bar is rigidly affixed relative to the housing and not free to rotate. Latch bar 30 engages corresponding teeth or otherwise elevated contours 32 on the face 14c of reel 14. Bevels on one side edge 30a of the latch bar 30 slide over the raised slopes 32a of the teeth or contours 32 when the reel 14 is rotating in direction B during unwinding of the leash 12 from the reel 14 as the leash 12 is being extended for example in direction C along the leash translation axis D, that is, extended through the aperture 16c in the top of the housing 16 by a user pulling on the housing 16 as a handle. For ease of winding and unwinding the leash from the reel, advantageously the leash translation axis D is substantially perpendicular to the axis of rotation A of reel 14.

When the tension is slackened on the leash 12 subsequent to the leash being unwound from the reel, the helical coil spring 22 urges the reel in the reverse direction so as to urge the reel to wind the leash back onto the reel. Rotation of the reel winding the leash back onto the reel is stopped by the non-bevelled edges 30b (opposite to bevelled side edges 30a) of the latch bar 30 engaging against the vertical faces 32b of the teeth or contours on the face of the reel.

When a user desires to retract the leash 12 onto the reel 14, the user depresses the external end 28b of the shaft or pin 28 thereby driving the shaft or pin in direction E so as to disengage the latch bar 30 from engagement from against the teeth or contours 32 on face 14c of reel 14 against the return biasing force of spring 34 mounted in seat 30c. Spring 34 pushes against side wall 16e. Once the latch bar 30 is so disengaged, the helical coil spring 22 urges rotation of reel 14 about axis of rotation A to thereby wind the leash 12 back onto reel 14 until the free end 12a of the leash engages the aperture 16c in the top of the housing 16.

In one preferred embodiment a swivel 36 is mounted on the free end 12a of the leash so as to allow the housing 16 and leash 12 to turn freely relative to the pet collar 20. The releasable fastener such as a clip 18 is mounted to the top of the swivel 36.

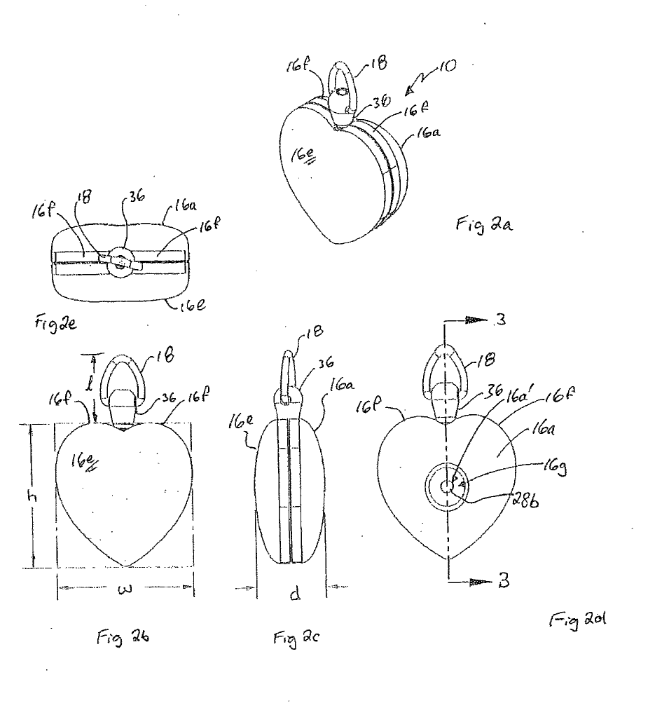

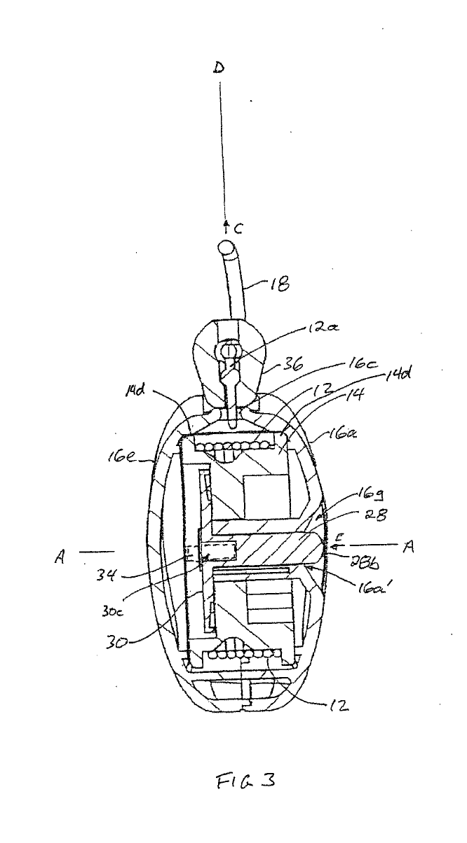

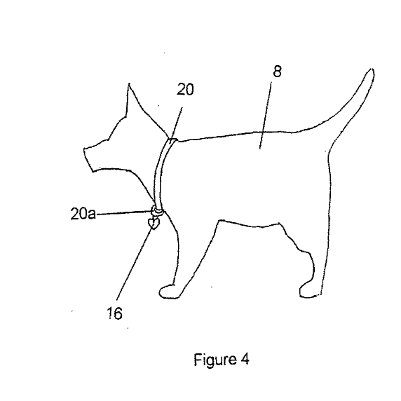

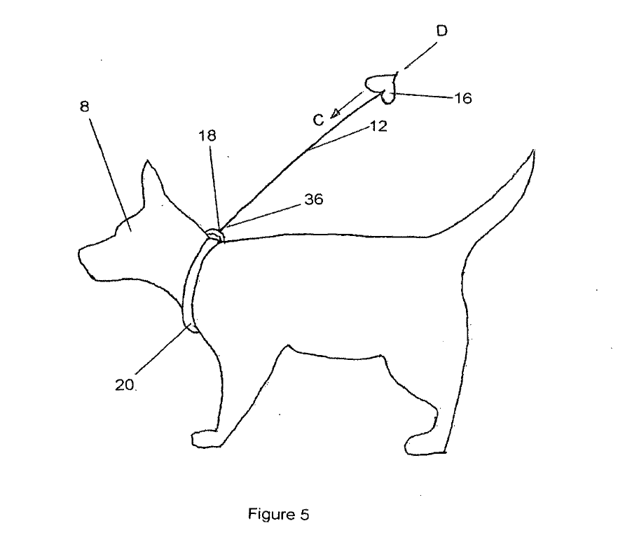

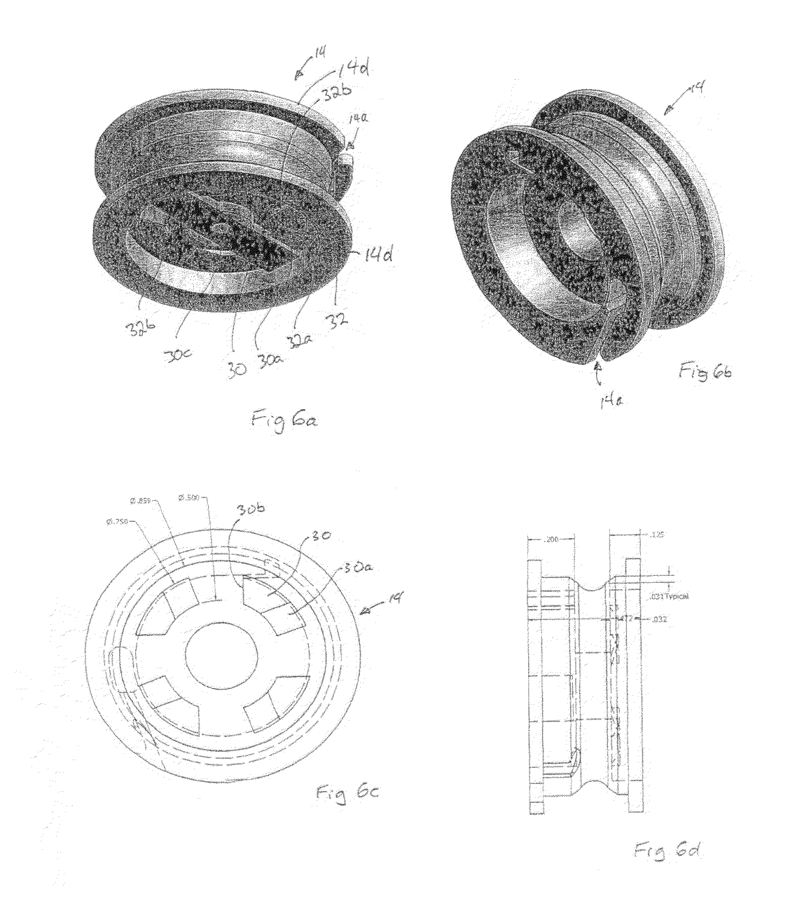

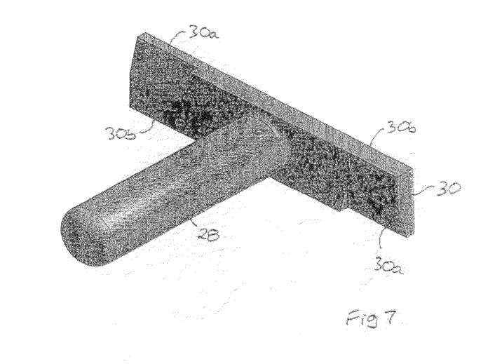

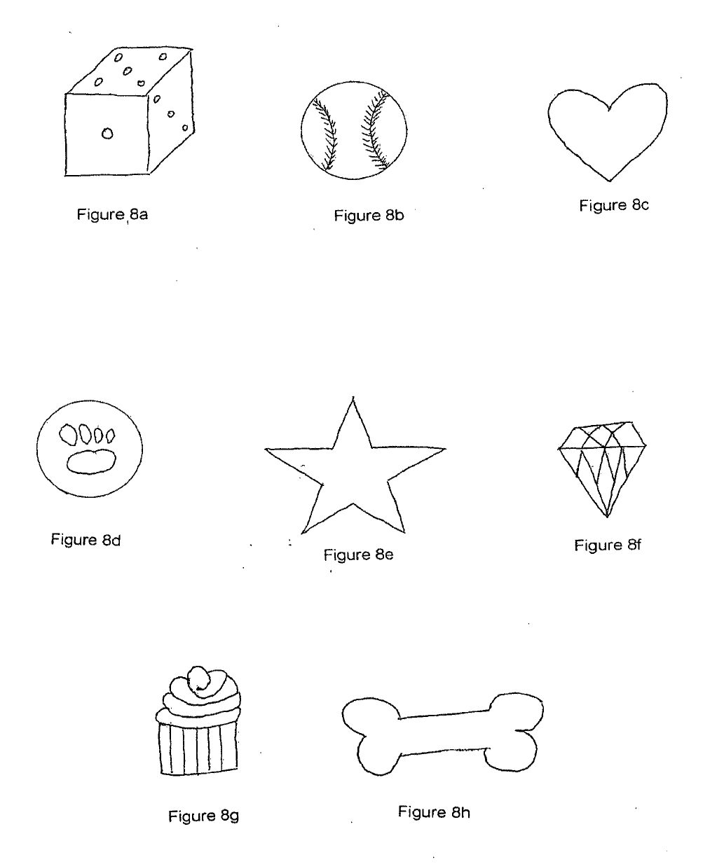

Although housing 16 may take many forms as shown by way of examples in FIGS. 2a and 8a-8f, one consistent and useful aspect is the bulk of the housing necessitated by having to contain reel 14. Reel 14 has to be large enough to contain a useful length of leash 12. Even if leash 12 is thin high-tensile strength filament, if leash 12 is for example three feet in length then leash 12 when fully wound onto reel 14 will require appreciable volume within cavity 16b. Reel 14 must accommodate the full length of leash 12 minus the short distance between reel 12 and aperture 16c at the top of the housing. Advantageously reel 14 as a raised pair of rims 14d that assist in containing the winding of leash 12 onto the reel. Rims 14d may slide over, in contact with, the inner surface of housing 16 to help avoid binding or jamming of the leash within the housing.

In one embodiment, not intending to be limiting for example for a smaller dog (under 25 lb dog) the exterior dimensions of housing 16 are approximately 1⅗ inches in width “w”, 1⅗ inches in height “h” (that is not including the height of the swivel 36 and clip 18), and ⅘ inches in thickness or depth “d”. Reel 14 may be approximately one inch in diameter, and ½ inch in depth. For larger dogs the dimensions may be larger. The use of shorter leash 12, and/or a finer filament for leash 12, allows reduction in the size of housing 16. As may be seen in the Figures, in one embodiment for ease of manufacturing, housing 16 may be formed by the joining together of two clam-shell halves. Cavity 16b in which reel 14 is mounted may be defined by the use of opposed-facing internal collars 38 formed in both halves of housing 16. Collars 38 help hold leash 12 on reel 14 by engaging against rims 14d during winding-on and unwinding of the leash. Spring 22 may be contained within a concentric ancillary collar 40, so for example spring 22 is then seated against sidewall 16a.

The coupler has a length dimension “l” substantially along the leash translation axis. A first ratio of the height dimension to the length dimension may be substantially in the range of 1-3:1 (height dimension of the housing:length dimension of the coupler). A second ratio of the width dimension to the length dimension may be substantially in the range of 1-3:1 (width dimension of the housing:length dimension of the coupler). A third ratio of the thickness dimension to the length dimension may be substantially in the range of 1-3:1 (thickness dimension of the housing:length dimension of coupler). These ratios generally define the bulk of the pendant housing 16 and the relative distance of the housings from the pet collar.

The bulk of reel 14 and the winding contained thereon forces the width dimension, the corresponding height dimension, and the depth dimension. Collectively, and in particular the width w and depth d dimensions, provide a comfortable-to-hold useful handle for a user to grasp, either by pulling the leash to extend it from the housing or to hold while controlling the pet. The various decorative forms of the housing will have a central volume to accommodate reel 14 and thus all provide the comfortable handle, especially those, such as the heart-shaped housing, which have expanded shoulders 16f on either side of aperture 16c which provided a laterally expanded area for improved purchase on the handle.

In the illustrated embodiment external end 28b which protrudes from aperture 16a′, is contained within a cup or depression 16g in side wall 16a. Thus a user will be less likely to inadvertently push end 28b thereby inadvertently retracting the leash.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A leash pendant for wearing by a pet, said pendant comprising:
a substantially hollow housing defining a cavity within said housing, an aperture in an upper end of said housing communicating with said cavity,
a leash reel rotatably mounted within said cavity for rotation about an axis of rotation, a flexible leash wrapped in a winding around said reel, said leash winding having a base end mounted to said reel so as to form a base of said winding, said leash having a free end, opposite to said base end of said leash winding, journalled through said aperture so as to be disposed outwardly of said housing, whereby said leash extends through said aperture for selective extension and retraction between extended and retracted positions, and wherein said aperture lies on a leash translation axis substantially perpendicular to said axis of rotation,
wherein said reel is resiliently biased by a selectively actuable rewinder to rotate said reel about said axis of rotation in a winding-on direction whereby said leash, when un-wound from said reel in said extended position so as to extend substantially along said leash translation axis, is re-wound onto said reel into said retracted position by selective actuation of said rewinder,
a pet collar coupler mounted to said free end of said leash, said pet collar coupler adapted for selectively releasable mounting to a pet collar so as to allow said housing to depend downwardly from the pet collar with said leash translation axis substantially vertical and with said upper end of said housing adjacent said pet collar coupler when said leash is in said retracted position whereby said housing hangs freely and downwardly, adjacent and underneath the pet collar when worn by a pet.

2. The device of claim 1 wherein said housing is sized to accommodate said reel and said winding on said reel, and wherein said leash is high-tensible strength filament of a length in the range of substantially two and one half to six feet, and wherein, because of a corresponding bulk of said reel and winding, and because said axis of rotation is said perpendicular to said leash translation axis, said housing has shoulders on opposite sides of said aperture to accommodate said bulk, whereby said shoulders provide a bulky handle for grasping by a user when tensioning said leash to said extend said leash from said housing against a resistance to said tensioning provided by said rewinder when said free end of said leash is anchored to the pet collar when worn by the pet.

3. The device of claim 2 wherein said housing has a shape to provide said shoulders, and wherein said shape is chosen from the group comprising: substantially a heart-shape, substantially a round-shape, substantially a rectangular or square paralleopiped, substantially insect-shaped, substantially animal-shaped, substantially flower-shaped, substantially ovoid, substantially tear-drop shaped, substantially star-shaped.

4. The device of claim 2 wherein said coupler includes a swivel for rotation of said housing about said leash translation axis.

5. The device of claim 2 wherein said housing has a height dimension along said leash translation axis, a thickness dimension along said axis of rotation, and a width dimension substantially orthogonal to said axis of rotation and said leash translation axis, and wherein said coupler has a length dimension substantially along said leash translation axis, and wherein a first ratio of said height dimension to said length dimension is in substantially a range of 1-3:1 (said height dimension of said housing:said length dimension of said coupler).

6. The device of claim 5 wherein a second ratio of said width dimension to said length dimension is substantially a range of 1-3:1 (said width dimension of said housing:said length dimension of said coupler).

7. The device of claim 5 wherein a third ratio of said thickness dimension to said length dimension is in substantially a range of 1-3:1 (said thickness dimension of said housing:said length dimension of said coupler).

8. The device of claim 2 further comprising a releasable one-way ratchet cooperating with said reel whereby said reel when rotated so as to unwind said winding through said aperture upon said tensioning unwinds against a return biasing resilient force of said rewinder, said return biasing resilient force checked by said one-way ratchet whereby when said leash is pulled from said housing by a user pulling on said housing said leash remains extended from said housing until said ratchet is released by the user, whereupon said rewinder resiliently urges rotation of said reel so as to re-wind said leash onto said reel to thereby retract said leash.

9. The device of claim 8 wherein said re-winder includes a resilient spring.

10. The device of claim 9 wherein said ratchet includes a resiliently biased latch bar and wherein said reel includes teeth for engaging with said latch bar, and wherein said latch bar is resiliently urged against said teeth so as to allow only one-way rotation of said reel corresponding to said un-winding of said reel.

11. The device of claim 10 further comprising a latch bar release manually operable from outside of said housing to selectively disengage said latch bar from said teeth to allow for said re-winding.

12. The device of claim 11 wherein said latch bar is elongate perpendicular to said axis of rotation and wherein said latch bar release is an elongate member extending along said axis of rotation, wherein one end of said member protrudes from said housing and an opposite end of said member engages against said latch bar, whereby depression of said one end of said member along said axis of rotation drives said latch bar along said axis of rotation and out of a plane of rotation of said teeth.
